(19) United States
(12) Patent Application Publication
(10) Pub. No.: US 2005/0029748 A1
(43) Pub. Date: Feb. 10, 2005

(54) Cylinder head gasket and combustion state detector using the same

(76) Inventors: Kenji Matsumoto, Okayama (JP); Eiji Tomita, Okayama (JP); Sadami Yoshiyama, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 10/938,523

(22) Filed: Sep. 13, 2004

Related U.S. Application Data
(63) Continuation of application No. 10/323,684, filed on Dec. 20, 2002.

(30) Foreign Application Priority Data
Dec. 20, 2001 (JP) 2001-387064

(51) Int. Cl. F02F 11/00

(52) U.S. Cl. 277/592

(57) ABSTRACT

A cylinder head gasket interposed between a cylinder head and a cylinder block in an engine comprising a metal thin plate having a thickness between 0.1 and 2.0 mm, and elastic insulating sheets placed on both surfaces of the metal thin plate and having a thickness between 0.01 and 0.5 mm, in which a portion at which the metal thin plate is exposed is created on the inner edge side extending from the inner side of the cylinder block, and an extension portion extending from the cylinder block is created on the outer edge side extending from the outer side of the cylinder block. A combustion state detector for detecting a combustion state of an engine, wherein the before described cylinder head gasket is interposed between the cylinder head and the cylinder block in an engine, the portion at which the metal thin plate is exposed is created on the extension portion of the cylinder head gasket, and the signal detecting means is connected thereto.

This application is a Continuation of U.S. Ser. No. 10/323,684, filed Dec. 20, 2002.

### BACKGROUND OF THE INVENTION

1. Field of the Invention

The present invention relates to a cylinder head gasket which is interposed between a cylinder head and a cylinder block in an engine, and has an ion sensor built in the said cylinder head gasket for detecting a combustion state of a combustion chamber of the said engine, and a combustion state detector using the same.

2. Description of the Related Art

As a combustion state detector for directly detecting a flame propagation condition within a combustion chamber of an engine, there has been conventionally known an device described in Japanese Patent Application Laid-Open (JP-A) No. 63-66431.

The combustion state detector described in JP-A No. 63-66431 is structured such that a cylinder head gasket having an ion sensor built in an insulation state is interposed between a cylinder head and a cylinder block in an engine. A leading end of an electrode of the ion sensor which is built in the cylinder head gasket faces to an interior side of the combustion chamber of the engine. Further, an electric potential is applied to a portion between the electrode of the ion sensor and the cylinder head, the cylinder block or the like corresponding to an earth electrode. Then, the combustion state within the combustion chamber can be detected by measuring an electric current value in a moment when the flame reaches the leading end of the electrode of the ion sensor.

Such as this detector, when the ion sensor is built in the cylinder head gasket interposed between the cylinder head and the cylinder block, it is possible to detect a combustion state of a portion to be detected at a high accuracy without being restricted by a placing position of the ion sensor.

In this case, at a time of interposing the cylinder head gasket between the cylinder head and the cylinder block, in order to improve a gas seal around a cylinder bore, it is necessary to increase surface pressures of upper and lower surfaces in the cylinder gasket.

However, in the case of increasing the surface pressures of the upper and lower surfaces in the cylinder head gasket, there is a case that a crack or the like is generated in a portion of the cylinder gasket which is in contact with upper and lower sides of the ion sensor due to a thickness of the electrode in the ion sensor built in the cylinder head gasket. When the crack or the like is generated, there is a disadvantage that an insulating property of the ion sensor can not be secured.

In order to prevent the crack or the like from being generated, it is considered that the electrode of the ion sensor is made thin and/or narrow as possible. However, when the electrode is made thin and/or narrow, there is generated a problem that the leading end facing to the combustion chamber side is melted due to the flame, and a hot surface ignition (a preignition) phenomenon is caused on the basis of the leading end serving as an ignition source, whereby the engine is broken.

### SUMMARY OF THE INVENTION

The present invention is made by taking the problems mentioned above into consideration, and an object of the present invention is to provide an engine combustion state detector in which a crack or the like is not generated in a cylinder head gasket even when surface pressures of upper and lower surfaces in a cylinder head gasket are increased, in spite that the detector is formed so that an ion sensor is built in a cylinder head gasket, which is interposed between a cylinder head and a cylinder block. And the other object of the present invention is to provide a cylinder head gasket suitable for the said engine combustion state detector.

That is to say, an object of the present invention is to increase a reliability against a flame in a leading end portion of the ion sensor facing to a combustion chamber side by the engine combustion state detector mentioned before and the cylinder head gasket suitable for the same, maintain the said increased reliability, and securely prevent a hot surface ignition from being generated.

In order to solve the problem mentioned above, one aspect of the present invention proposes a cylinder head gasket interposed between a cylinder head and a cylinder block in an engine comprising: a metal thin plate having a thickness between 0.1 and 2.0 mm; and elastic insulating sheets placed on both surfaces of the metal thin plate and having a thickness between 0.01 and 0.5 mm, wherein a portion at which the metal thin plate is exposed is created on the inner edge side extending from the inner side of the cylinder block, and an extension portion extending from the cylinder block is created on the outer edge side extending from the outer side of the cylinder block.

The cylinder head gasket according to the present invention is used for the engine combustion state detector, and the metal thin plate serves as an ion sensor. And, the before described portion at which the metal thin plate is exposed created on the inner edge side extending from the inner side of the cylinder block serves as the leading end portion facing to the combustion chamber side of the ion sensor, and is in contact with a combustion gas in the combustion chamber. Further, at the before described extension portion of the cylinder head gasket created on the outer edge side of the cylinder head gasket extending from the outer side of the cylinder block, the portion at which the metal thin plate is exposed is created, and the signal detecting means of the combustion state detector is connected hereto.

In the before described cylinder head gasket of the present invention, the before described portion at which the metal thin plate is exposed created on the inner edge side of the cylinder head gasket extending from the inner side of the cylinder block may be created by removing the elastic insulating sheet from the portion of the cylinder head gasket extending from the inner side of the cylinder block.

Also, in the before described, the cylinder head gasket of the present invention, the said cylinder head gasket can be made by arranging the elastic insulating sheets on both surfaces of the metal thin plate, thereafter punching in a predetermined shape and then subjected to bead work. In this bead work, suitable beads are formed in the required portion.

In the present invention, the elastic insulating sheet mentioned above comprises an inorganic fiber and/or an organic fiber, an inorganic filler and a rubber binder.

In this case, as the inorganic fiber, a glass fiber, a potassium titanate and the like can be employed.

As the organic fiber, a rock wool, an aramid fiber, a cellulose fiber, a polyester fiber, a polyamide fiber and the like can be employed.

As the inorganic filler, a silica, a clay, a calcium carbonate and the like can be employed.

Further, as the rubber binder, a NBR (nitrile butadiene rubber) is generally employed, however, any one of an acrylic rubber, a silicon rubber, an isoprene rubber, a chloroprene rubber and the like may be employed, in addition.

The metal thin plate in which the elastic insulating sheets are created on both of the upper and lower surfaces, may be formed by using an SUS, a spring steel, an SPCC or the like.

Next, in order to achieve the objects mentioned above, one aspect of the present invention proposes an engine combustion state detector for detecting the combustion state of an engine, wherein a cylinder head gasket in which elastic insulating sheets comprising an inorganic fiber and/or an organic fiber, an inorganic filler, and a rubber binder are arranged on both surfaces of a metal thin plate, is interposed between the cylinder head and the cylinder block in an engine, a portion at which the metal thin plate is exposed is created on the inner edge side of the said cylinder head gasket extending from the inner side of the cylinder block, an extension portion extending from the cylinder block is created on the outer edge side of the said cylinder head gasket extending from the outer side of the cylinder block, a portion at which the metal thin plate is exposed is created on said extension portion, and the signal detecting means is connected thereto.

Further, another aspect of the present invention proposes an engine combustion state detector for detecting the combustion state of an engine, wherein any one of the before described cylinder head gaskets of the present invention is interposed between the cylinder head and the cylinder block in an engine, the portion at which the metal thin plate is exposed is created on the before described extension portion of the cylinder head gasket, and the signal detecting means is connected thereto.

A plurality of laminated cylinder head gaskets as described in any one of the preceding aspects of the present invention may be interposed between the cylinder head and the cylinder block. In this case, the signal detecting means is connected to the portion at which the metal thin plate is exposed on the before described extension portion of at least one cylinder head gasket in a plurality of cylinder head gaskets.

According to an aspect that a plurality of cylinder gaskets are interposed in a laminated manner between the cylinder head and the cylinder block in the engine, a good result is achieved in view of a detection accuracy of a combustion state and an improvement of a sealing performance.

In the cylinder head gasket for the combustion state detector according to the present invention mentioned above, since the elastic insulating sheets are created on both of the upper and lower surfaces of the metal thin plate corresponding to the ion sensor, it is possible to improve a sealing characteristic in addition to a durability of the cylinder head gasket.

In the conventional combustion state detector, there has been employed a structure in which the electrode portion is connected to the ion sensor built in the cylinder head gasket, however, in the cylinder head gasket and the combustion state detector according to the present invention, it is possible to omit the structure in which the electrode portion is connected as mentioned above. Further, since the conduction is directly applied via the metal thin plate, it is possible to accurately and securely detect the combustion state.

Further, since the elastic insulating sheets are created on both of the upper and lower surfaces of the metal thin plate corresponding to the ion sensor, no unreasonable stress is generated in the cylinder head gasket even when the surface pressures of the upper and lower surfaces in the cylinder head gasket are increased for the purpose of improving the gas seal around the cylinder bore, so that it is possible to prevent the crack or the like from being generated.

Since the thickness of the elastic insulating sheet is between 0.01 and 0.5 mm, the thickness of the cylinder head gasket is not caused to be changed even when the surface pressures of the upper and lower surfaces in the cylinder head gasket is increased for the purpose of improving the gas seal around the cylinder bore, so that a uniform thickness is kept in a compression portion, and no crack or the like is generated. Accordingly, it is possible to maintain a good insulating property of the metal thin plate corresponding to the ion sensor.

Further, in the metal thin plate corresponding to the ion sensor, since the elastic insulating sheets having the thickness mentioned above are created on both of the upper and lower surfaces thereof, and the thickness is between 0.1 and 2.0 mm, there is not generated problems such that the leading end facing to the combustion chamber side is melted due to the flame, and the hot surface ignition (the preignition) phenomenon is produced by the leading end corresponding to the ignition source, whereby the engine is broken. Accordingly, it is possible to increase a reliability of the leading end portion of the ion sensor facing to the combustion chamber side and it is possible to maintain the increased reliability.

That is, according to the present invention, it is possible to improve a reliability of the cylinder head gasket for the engine combustion state detector as well as to improve a reliability of the engine combustion state detector.

Further, as mentioned above, in the engine combustion state detector proposed by the present invention, since the cylinder head gasket in which the elastic insulating sheets are created on both of the upper and lower surfaces of the metal thin plate serving as the ion sensor is interposed between the cylinder head and the cylinder block in the engine, and the portion at which the metal thin plate is exposed is created on the inner edge side of the cylinder head gasket extending from the inner side of the cylinder block, it is possible to expand an exposed area up to all the periphery of the combustion chamber in the engine.

### BRIEF DESCRIPTION OF THE DRAWINGS

FIG. 1 is a partly omitted cross sectional view describing a state in which an engine combustion state detector according to one embodiment of the present invention is arranged between a cylinder head and a cylinder block;

FIG. 2 is a plan view of a cylinder head gasket according to one embodiment of the present invention; and

FIG. 3 is a cross sectional view of a part corresponding to an A-A line portion in FIG. 2, which describes a state in which an engine combustion state detector according to one embodiment of the present invention is arranged between a cylinder head and a cylinder block.

### DESCRIPTION OF THE PREFERRED EMBODIMENT

A description will be given below of a preferred embodiment according to the present invention with reference to the accompanying drawings.

Elastic insulating sheets 32 and 32 containing an NBR (nitrile butadiene rubber), a rock wool and a silica and having a thickness of 0.05 mm each respectively are created on both of upper and lower surfaces of a metal thin plate 31 having a thickness 0.5 mm and made of SUS.

Thereafter, these sheets are punched out in a required shape in correspondence to shapes of a cylinder head 1 and a cylinder block 2 in which a cylinder head gasket is interposed. At this time, they are punched out so that an extension portion 33 extending from the cylinder block 2 is created on the outer edge portion of the cylinder head gasket extending from the outer side of the cylinder block 2, when the cylinder head gasket is interposed between the cylinder head 1 and the cylinder block 2. Then, it is necessary to improve a strength, suitable beads are formed in the required portions.

Thereafter, the elastic insulating sheets 32 in an inner edge side of the cylinder head gasket extending from the inner side of the cylinder block 2 when the cylinder head gasket is interposed between the cylinder head 1 and the cylinder block 2 is removed, so that the metal thin plate 31 at this portion is exposed. The portion of the exposed metal thin plate 31 corresponds to a portion being in contact with a combustion gas in a combustion chamber side of an engine.

The cylinder head gasket 3 according to the present invention is manufactured in this manner mentioned above.

In this case, when removing the elastic insulating sheets 32 from the extension portion 33 and making the metal thin plate 31 in this portion be exposed, the portion of the exposed metal thin plate 31 corresponds to a signal pickup portion, and signal detecting means is connected thereto.

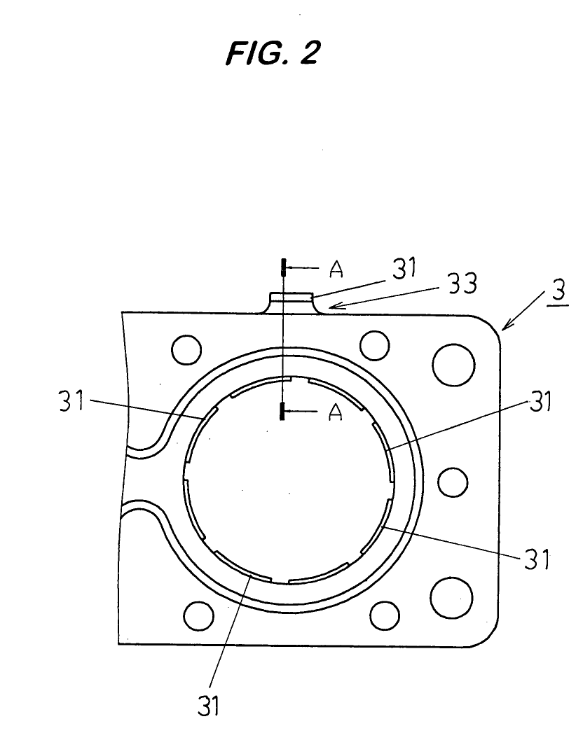

As described above, a structure in a state shown in FIG. 2 in which not only the portion at which the metal thin plate 31 is exposed is created on the inner edge side, but also the portion at which the metal thin plate 31 is exposed is created on the extension portion 33, may be also called as the cylinder head gasket according to the present invention.

The cylinder head gasket 3 according to the present invention manufactured in the manner mentioned above is interposed between the cylinder head 1 and the cylinder block 2 in the engine, thereby constructing the engine combustion state detector according to the present invention in the following manner.

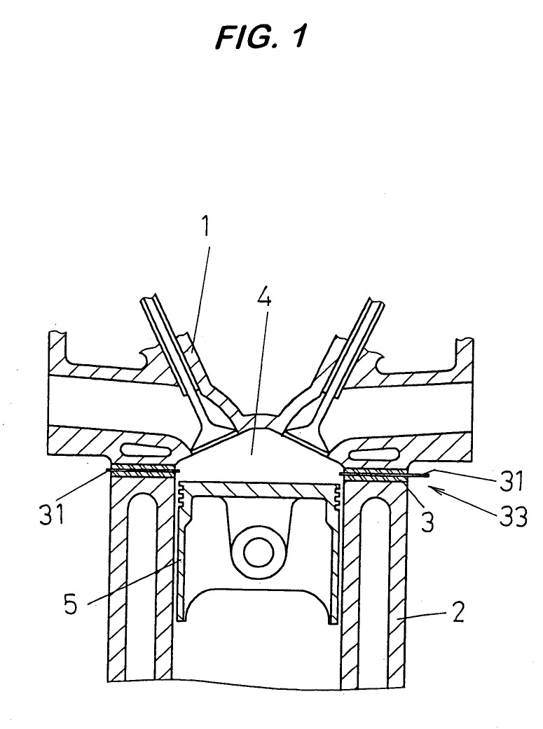

The engine is provided with the cylinder block 2, a piston 5 reciprocating within the cylinder block 2 and the cylinder head 1 covering an upper portion of the cylinder block 2, as shown in FIG. 1, and a combustion chamber 4 is defined by the piston 5 and the cylinder head 1.

The cylinder head gasket 3 structured in the manner mentioned above is interposed between the cylinder block 2 and the cylinder head 1 in the engine as shown in FIG. 1.

Since the cylinder head gasket 3 is manufactured in the manner mentioned above, the metal thin plate 31 is exposed within the combustion chamber 4 in a peripheral shape. This peripherally exposed metal thin plate portion corresponds to a portion which is in contact with the combustion gas in the ion sensor.

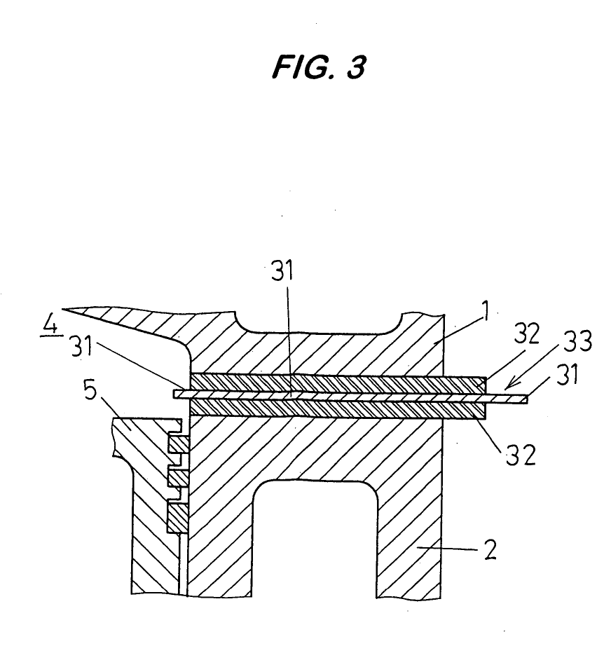

Further, as shown in FIG. 3, the portion in which the elastic insulating sheets 32 in the portion of the extension portion 33 is removed and to which the metal thin plate 31 is exposed, corresponds to a signal pickup portion.

The engine combustion state detector according to the present invention is constructed by connecting a conventionally known signal detecting means (not shown) to the signal pickup portion.

The engine combustion state is detected by the combustion state detector according to the present invention in the following manner.

Any one of the cylinder head 1 and the cylinder block 2 is set as an earth electrode, and an electric potential of 90 V is applied between this earth electrode and the portion of the extension portion 33 at which the metal thin plate 31 serving as the ion sensor is exposed.

An electric circuit is formed through a flame band in an ion state in a moment that the flame reaches a portion (a left side in FIG. 3) of the metal thin plate 31 disposed in adjacent to the combustion chamber 4 in the cylinder head gasket 3, whereby an electric current is flowed. This electric current value is picked up through the signal detecting means (not shown) connected to the exposed metal thin plate 31 (the signal pickup portion) in the portion of the extension portion 33, and the combustion state within the combustion chamber 4 is detected by measuring the electric current value. The electric current value can be measured, for example, by amplifying the electric current value picked up through the signal detecting means (not shown) connected to the exposed metal thin plate 31 (the signal pickup portion) in the portion of the extension portion 33 by means of an amplifier, and processing by means of a signal processor.

Although the present invention has been described in particular reference to preferred embodiment thereof, it should be understood that various changes and modifications may be made without departing from the spirit and scope of the invention as defined in the appended claims.

1. A cylinder head gasket interposed between a cylinder head and a cylinder block in an engine comprising:
a metal thin plate having a thickness between 0.1 and 2.0 mm; and
elastic insulating sheets placed on both surfaces of the metal thin plate and having a thickness between 0.01 and 0.5 mm,
wherein a portion at which the metal thin plate is exposed is created on the inner edge side extending from the inner side of the cylinder block, and
an extension portion extending from the cylinder block is created on the outer edge side extending from the outer side of the cylinder block.

2. The cylinder head gasket according to claim 1, wherein the portion at which the metal thin plate is exposed and which is created on the inner edge side extending from the inner side of the cylinder block is created by removing the elastic insulating sheet from the portion extending from the inner side of the cylinder block on the cylinder head gasket.

3. The cylinder head gasket according to claim 1, wherein after the elastic insulating sheets are arranged on both surfaces of the metal thin plate, it is punched in a predetermined shape and then subjected to bead work.

4. The cylinder head gasket according to claim 2, wherein after the elastic insulating sheets are arranged on both surfaces of the metal thin plate, it is punched in a predetermined shape and the subjected to bead work.

5. The cylinder head gasket according to claim 1, wherein the elastic insulating sheet comprises an inorganic fiber and/or an organic fiber, an inorganic filler and a rubber binder.

6. The cylinder head gasket according to claim 2, wherein the elastic insulating sheet comprises an inorganic fiber and/or an organic fiber, an inorganic filler and a rubber binder.

7. The cylinder head gasket according to claim 3, wherein the elastic insulating sheet comprises an inorganic fiber and/or an organic fiber, an inorganic filler and a rubber binder.

8. The cylinder head gasket according to claim 4, wherein the elastic insulating sheet comprises an inorganic fiber and/or an organic fiber, an inorganic filler and a rubber binder.

9. A combustion state detector for detecting the combustion state of an engine,
wherein a cylinder head gasket in which elastic insulating sheets comprising an inorganic fiber and/or an organic fiber, an inorganic filler, and a rubber binder are arranged on both surfaces of a metal thin plate, is interposed between the cylinder head and the cylinder block in an engine,
a portion at which the metal thin plate is exposed is created on the inner edge side of the cylinder head gasket extending from the inner side of the cylinder block,
an extension portion extending from the cylinder block is created on the outer edge side of the cylinder head gasket extending from the outer side of the cylinder block,
the portion at which the metal thin plate is exposed is created on said extension portion, and the signal detecting means is connected thereto.

10. A combustion state detector for detecting the combustion state of an engine, wherein the cylinder head gasket according to claim 1 is interposed between the cylinder head and the cylinder block, a portion at which the metal thin plate is exposed is created on said extension portion of the cylinder head gasket, and the signal detecting means is connected thereto.

11. A combustion state detector for detecting the combustion state of an engine, wherein the cylinder head gasket according to claim 2 is interposed between the cylinder head and the cylinder block, a portion at which the metal thin plate is exposed is created on said extension portion of the cylinder head gasket, and the signal detecting means is connected thereto.

12. A combustion state detector for detecting the combustion state of an engine, wherein the cylinder head gasket according to claim 3 is interposed between the cylinder head and the cylinder block, a portion at which the metal thin plate is exposed is created on said extension portion of the cylinder head gasket, and the signal detecting means is connected thereto.

13. A combustion state detector for detecting the combustion state of an engine, wherein the cylinder head gasket according to claim 5 is interposed between the cylinder head and the cylinder block, a portion at which the metal thin plate is exposed is created on said extension portion of the cylinder head gasket, and the signal detecting means is connected thereto.

14. A combustion state detector for detecting the combustion state of an engine,
wherein a plurality of laminated cylinder head gaskets according to claim 1 are interposed between the cylinder head and the cylinder block, and the signal detecting means is connected to the portion of at least one cylinder head gasket in a plurality of cylinder head gaskets at which the metal thin plate is exposed on the extension portion.

15. A combustion state detector for detecting the combustion state of an engine,
wherein a plurality of laminated cylinder head gaskets according to claim 2 are interposed between the cylinder head and the cylinder block, and the signal detecting means is connected to the portion of at least one cylinder head gasket in a plurality of cylinder head gaskets at which the metal thin plate is exposed on the extension portion.

16. A combustion state detector for detecting the combustion state of an engine,
wherein a plurality of laminated cylinder head gaskets according to claim 3 are interposed between the cylinder head and the cylinder block, and the signal detecting means is connected to the portion of at least one cylinder head gasket in a plurality of cylinder head gaskets at which the metal thin plate is exposed on the extension portion.

17. A combustion state detector for detecting the combustion state of an engine,
wherein a plurality of laminated cylinder head gaskets according to claim 5 are interposed between the cylinder head and the cylinder block, and the signal detecting means is connected to the portion of at least one cylinder head gasket in a plurality of cylinder head gaskets at which the metal thin plate is exposed on the extension portion.
